(19) United States
(12) Patent Application Publication
(10) Pub. No.: US 2024/0014458 A1
(43) Pub. Date: Jan. 11, 2024

(54) BATTERY THERMAL MANAGEMENT

(71) Applicant: GoPro, Inc., San Mateo, CA (US)

(72) Inventors: Raul Vargas Gonzalez, Redwood City, CA (US); Ian Copeland Griggs, San Francisco, CA (US); David Thomas Platner, San Francisco, CA (US); Matthew Hardcastle, San Francisco, CA (US)

(21) Appl. No.: 18/218,812

(22) Filed: Jul. 6, 2023

Related U.S. Application Data
(60) Provisional application No. 63/358,970, filed on Jul. 7, 2022.

(51) Int. Cl. H01M 10/615; H01M 10/635; H01M 10/623; H01M 10/44

(52) U.S. Cl. CPC H01M 10/615; H01M 10/635; H01M 10/623; H01M 10/443

(57) ABSTRACT

Heating of an image capture apparatus battery to an operational temperature using an attached heater device is described. The image capture apparatus includes an image capture apparatus battery configured to functionally operate at a first operational temperature. The heater device includes a heater device battery configured to operate at a second operational temperature lower than the first operational temperature. A heater controller is implemented in one of the image capture apparatus or the heater device. The heater controller is configured to initiate a heating process based on a first defined event, set a current level of the heater device, maintain or adjust the current level of the heater device until a second defined event, and display an indication that the image capture apparatus can detect, capture, or record an image based on the image capture apparatus battery attaining the first operational temperature.

### CROSS-REFERENCE TO RELATED APPLICATION(S)

This application claims priority to and the benefit of U.S. Patent Application Ser. No. 63/358,970, filed on Jul. 7, 2022, the entire disclosure of which is hereby incorporated by reference.

### TECHNICAL FIELD

This disclosure relates to controlled heating of a battery of an image capture apparatus to enable functional operations in colder environments.

### BACKGROUND

In cold climates, typical Lithium-ion batteries may not provide enough electrical power to keep electronic devices turned on or provide sufficient electrical power to execute functional operations. For example, an image capture apparatus may be unable to capture and/or record images or video.

### SUMMARY

Disclosed herein are implementations for battery thermal management.

In an aspect, an image capture system includes an image capture apparatus including an image capture apparatus battery configured to functionally operate at a first operational temperature, a heater device including a heater device battery configured to operate at a second operational temperature lower than the first operational temperature, the heater device configured to thermally couple to the image capture apparatus battery, and at least one of the image capture apparatus or the heater device including a heater controller configured to initiate a heating process based on a first defined event, set a current level of the heater device, maintain or adjust the current level of the heater device until a second defined event, and display an indication that the image capture apparatus can detect, capture, or record an image based on the image capture apparatus battery attaining the first operational temperature.

With respect to the image capture system aspect, the heater device includes a heating element and a heat spreader. With respect to the image capture system aspect, the heater controller is further configured to set the current level of the heater device to zero upon initiation of the heating process, read one or more temperature measurements indicative of a temperature of the image capture apparatus battery, wherein the first defined event indicates that the one or more temperature measurements fall within a heater device operational range and the second defined event is attained when an image capture apparatus battery temperature attains the first operational temperature, and adjust the current level of the heater device, wherein the read and adjust are repeated until the second defined event. With respect to the image capture system aspect, the heater controller is further configured to turn off the heater device when the one or more temperature measurements include an ambient temperature indicating that heating of the image capture apparatus battery is unnecessary. With respect to the image capture system aspect, the heater controller is further configured to turn off the heater device when the one or more temperature measurements include an ambient temperature indicating that heating of the image capture apparatus battery to the first operational temperature is unattainable. With respect to the image capture system aspect, the heater controller is further configured to set the current level of the heater device to zero when the one or more temperature measurements include a heater device battery temperature indicating that the heater device battery is overheating. With respect to the image capture system aspect, the heater controller is further configured to set the current level of the heater device to zero when the one or more temperature measurements include the image capture apparatus battery temperature indicating that the image capture apparatus battery temperature is at a defined value above the first operational temperature. With respect to the image capture system aspect, the heater controller is further configured to maintain the current level of the heater device when the one or more temperature measurements include the image capture apparatus battery temperature indicating that the image capture apparatus battery temperature is at the first operational temperature. With respect to the image capture system aspect, the first defined event occurs when a timer is set by the heater controller and the second defined event occurs when the timer expires, the heater controller is further configured to set the current level of the heater device to zero upon initiation of the heating process and set the current level of the heater device to zero when the second defined event occurs. With respect to the image capture system aspect, the heater controller is further configured to set the current level of the heater device to zero upon initiation of the heating process, read one or more temperature measurements indicative of a temperature of the image capture apparatus battery, wherein the one or more temperature measurements is an interface temperature measurement and the first defined event indicates that an interface temperature measurement is below the first operational temperature and second defined event is attained when the interface temperature measurement attains the first operational temperature, and adjust the current level of the heater device, wherein the read and adjust are repeated until the second defined event.

In another aspect, a method for heating an image capture apparatus battery using a heater device includes thermally coupling a heater device to an image capture apparatus battery of an image capture device, wherein a heater device battery operational temperature is lower than an image capture apparatus battery operational temperature, obtaining one or more temperature measurements indicative of a temperature of the image capture apparatus battery, setting a current level of the heater device, maintaining or adjusting the current level of the heater device until a defined event, and displaying an indication that the image capture apparatus can detect, capture, or record an image.

With respect to the method aspect, the setting further includes determining that the one or more temperature measurements fall within a heater device operational range. With respect to the method aspect, the method further includes foregoing the setting when the one or more temperature measurements indicate that heating of the image capture apparatus battery is unnecessary. With respect to the method aspect, the method further includes foregoing the setting when the one or more temperature measurements indicate that heating of the image capture apparatus battery to an operational temperature of the image capture apparatus battery is unattainable. With respect to the method aspect, the method further includes setting the current level of the heater device to zero when the one or more temperature measurements include a heater device battery temperature indicating that the heater device battery is overheating. With respect to the method aspect, the method further includes setting the current level of the heater device to zero when the one or more temperature measurements include an image capture apparatus battery temperature indicating that the image capture apparatus battery temperature is at a defined value above the image capture apparatus battery operational temperature. With respect to the method aspect, the method further includes maintaining the current level of the heater device when the one or more temperature measurements include an image capture apparatus battery temperature indicating that the image capture apparatus battery temperature is at the image capture apparatus battery operational temperature. With respect to the method aspect, the one or more temperature measurements are taken from the heater device.

In yet another aspect, a method for heating an image capture apparatus battery using a heater device includes thermally attaching a heater device to an image capture apparatus battery of an image capture device, wherein a heater device battery operational temperature is lower than an image capture apparatus battery operational temperature, setting a timer, setting a current level of the heater device, maintaining the current level of the heater device until expiration of the timer, and displaying an indication that the image capture apparatus can detect, capture, or record an image.

With respect to the method aspect, the method further includes turning off the heater device by a user irrespective of the timer.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture apparatus.

FIGS. 2A-B are isometric views of another example of an image capture apparatus.

FIG. 3 is a block diagram of electronic components of an image capture apparatus.

FIG. 4 is a block diagram of an example image capture apparatus with a heater device.

FIG. 5 is a perspective view of an example image capture apparatus with an attached heater device.

FIG. 6 is a perspective view of another example image capture apparatus with an attached heater device.

FIG. 7 is a partial non-occluded view of an attachment interface of the example image capture apparatus with an attached heater device of FIG. 6.

FIG. 8 is a perspective view of the image capture apparatus 600 with the attached heater device 610 in an open position.

FIG. 9 is a partial non-occluded view of the heater device battery 610 of FIG. 6.

FIG. 10 is a perspective view of another example image capture apparatus with a heater device.

FIG. 11 is an exploded, perspective view of another example image capture apparatus with a heater device and an image capture apparatus battery.

FIG. 12 is a perspective view of an example heating element for a heater device.

FIG. 13 is a perspective view of another example heating element for a heater device.

FIG. 14 is a perspective view of a surface of a heat spreader for heating element of the heater device of FIG. 13.

FIG. 15A is a perspective view of an example image capture apparatus.

FIG. 15B is a perspective view of an example heater device for operation with the image capture apparatus of FIG. 15A.

FIG. 15C is a perspective view of the image capture apparatus of FIG. 15A in thermal connection with the heater device of FIG. 15B.

FIG. 16 is a flow diagram of an example technique for controlling heating of an image capture apparatus battery.

FIG. 17 is a flow diagram of another example technique for controlling heating of an image capture apparatus battery.

FIG. 18 is a flow diagram of another example technique for controlling heating of an image capture apparatus battery.

FIG. 19 is a flowchart of an example technique for heating an image capture apparatus battery to a recording temperature.

### DETAILED DESCRIPTION

Image capture apparatus are used in a wide variety of climates or environments for a wide variety of activities. For example, these activities can include, but are not limited to, skiing, snowboarding, ice fishing, dog sledding, night captures such as the Northern Lights, ice skating, outdoor hockey or broomball, winter heavy equipment use such as snowplowing, snow removal, or construction, winter open water related activities such as fishing, crabbing, whale watching, and fjord cruising, snow kiting, snow motocross, snow jumping, Nordic skiing, snowmobiling, hiking, snowshoeing, winter camping, science, and hunting. The temperatures for performing or participating in these activities can be well below the operational range of the batteries or power sources used in the image capture apparatus. This can limit the use of the image capture apparatus.

For example, a user may want to capture night lapse imagery of the Milky Way and the Northern Lights above a mountain. Overnight temperatures are in the single digits and below 0° C. Upon awakening, the user wants to be able to turn the image capture apparatus on from a cold start and begin filming immediately. However, due to the limitations of the battery, the image capture apparatus stops recording at 50% battery life, the image capture apparatus is too cold to start, or the image capture apparatus has to placed inside a warm jacket prior to starting up. In this instance, the user needs a battery system which will keep the image capture apparatus warm while filming for an extended time in cold weather environments.

In another example, a hockey coach wears the image capture apparatus on their head while skating with the team in an outdoor practice. The coach uses hindsight to be able to capture moments from the practice, so the image capture apparatus is idly recording for up to an hour at a time while being exposed to cold temperatures. However, due to the limitations of the battery, the image capture apparatus does not last through the 1-2 hour practice in the cold weather.

In a further example, an ice fisherman has an image capture apparatus on a tripod next to their ice fishing hole. The ice fisherman needs the image capture apparatus to be able to start from a cold start to capture the moment a fish is caught and is being reeled in. However, due to the limitations of the battery, the ice fisherman has had issues where the image capture apparatus dies prematurely, missing the opportunity.

In yet another example, a camera production expert wants to film car commercials in cold temperatures. The camera production expert has an image capture apparatus on the underside of a vehicle to capture tire imagery while the vehicle travels around a test track in northern Michigan. The image capture apparatus is exposed to cold temperatures, and must be able to perform in this mission critical environment. The following weekend, the camera production expert is traveling to the Winter X Games and will be placing the image capture apparatus on athletes and machinery (such as motorcycles and snowmobiles) throughout the weekend. However, due to the limitations of the battery, the camera production expert has had issues where shots are missed due to the unreliability of the image capture apparatus.

In still another example, a user uses an image capture apparatus while snowmobiling in Alaska at 60 mph in cold temperatures. Due to the limitations of the battery, the user has noticed that image capture apparatus can get very cold through convective cooling and recording has stopped prematurely.

In all these instances, users need a battery system which will keep the image capture apparatus warm while filming for an extended time in cold weather environments.

The implementations disclosed herein is an attachable heater device or module for an image capture apparatus or camera. The attachable heater device can heat or pre-heat a battery of the image capture apparatus above the image capture apparatus battery's minimum rated operating temperature to enable it to operate in colder climates. In this instance, colder climates refers to climates or environments below the minimum rated operating temperature of the battery of the image capture apparatus.

In some implementations, the attachable heater device can include a battery pack or power source, a heat source or heating element, electronics, and a controller or control logic. The battery pack can have an operating temperature lower than that of the battery of the image capture apparatus. In some implementations, the battery pack can include disposable batteries, rechargeable batteries, and/or combinations thereof. In some implementations, the heating device can be coupled, thermally coupled, attached, or thermally attached to the battery of the image capture device using, for example, thermally conductive materials. In some implementations, the heating device can be coupled, thermally coupled, attached and/or thermally attached to the battery of the image capture device via, for example, thermally conductive materials and image camera device housing or portions thereof. In some implementations, the coupling, thermal coupling, attachment and/or thermal attachment can be a direct coupling or attaching, an indirect coupling or attaching, and/or combinations thereof. In some implementations, the electronics can include a power on/off button, battery power level light-emitting diodes (LEDs), heating indicator LEDs, status LEDs, timers, and preset timers. In some implementations, the controller can provide smart control of the attachable heater device and battery of the image capture apparatus based on temperature measurements from sensors in the attachable heater device, sensors in the battery of the image capture apparatus, sensors in the image capture apparatus, and/or combinations thereof. In some implementations, the image capture apparatus an include controller or control logic to interact with the attachable heater device. In some implementations, the attachable heater device and the image capture apparatus can cooperatively control the heating of the battery in the image capture apparatus. In some implementations, an electrical connection or connector, such as a universal serial bus (USB) interface or connector or a prong-type interconnect, can be used to obtain sensor measurements from a respective one of the image capture apparatus or the attachable heater device and for control of the attachable heater device, as appropriate.

In some implementations, an attachable heater device can be a module which slidably attaches to or hinges on an image capture apparatus such that a heating element is thermally optimally in connection with an exposed surface of a battery of an image capture apparatus. In some implementations, an attachable heater device can be a module which attaches to a housing of an image capture apparatus such that a heating element is thermally optimally placed or juxtaposed in relation to a battery of the image capture apparatus. An intelligent active algorithm or user driven actions can drive the attachable heater device and ensure that a temperature of a battery in the image capture apparatus stays above an operational threshold so that the image capture apparatus can turn on and perform reliably.

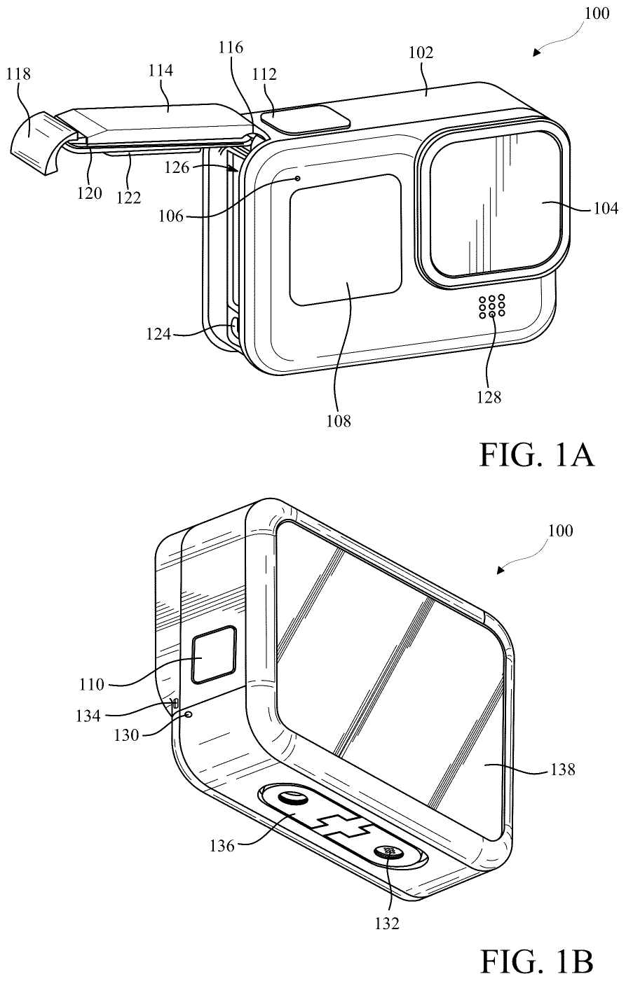

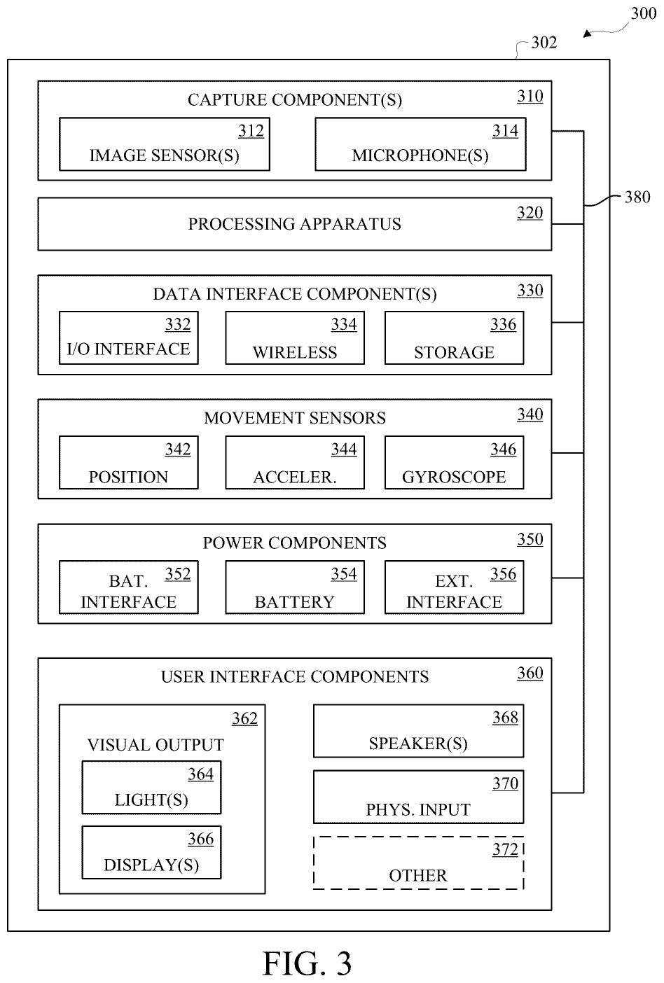

FIGS. 1A-B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, a speaker 132, an interconnect mechanism 136, and a display 138. Although not expressly shown in FIG. 1, the image capture apparatus 100 includes internal electronics, such as imaging electronics, power electronics, and the like, internal to the body 102 for capturing images and performing other functions of the image capture apparatus 100. An example showing internal electronics is shown in FIG. 3. The arrangement of the components of the image capture apparatus 100 shown in FIGS. 1A-B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used.

As shown in FIG. 1A, the image capture apparatus 100 includes the image capture device 104 structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. Although one display 108 is shown in FIG. 1A, the image capture apparatus 100 may include multiple displays, which may be structured on respective surfaces of the body 102. In some implementations, the display 108 may be omitted or combined with another component of the image capture apparatus 100.

As shown in FIG. 1B, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1B, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. Although described as a button, the shutter button 112 may be another type of input device, such as a switch, a toggle, a slider, or a dial. Although one shutter button 112 is shown in FIG. 1A, the image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1A, the image capture apparatus 100 includes the door 114 coupled to the body 102, such as using the hinge mechanism 116. The door 114 may be secured to the body 102 using the latch mechanism 118 that releasably engages the body 102 at a position generally opposite the hinge mechanism 116. As shown in FIG. 1A, the door 114 includes the seal 120 and the battery interface 122. Although one door 114 is shown in FIG. 1A, the image capture apparatus 100 may include multiple doors respectively forming respective surfaces of the body 102, or portions thereof. Although not shown in FIGS. 1A-B, the door 114 may be removed from the body 102 by releasing the latch mechanism 118 from the body 102 and decoupling the hinge mechanism 116 from the body 102.

In FIG. 1A, the door 114 is shown in an open position such that the data interface 124 is accessible for communicating with external devices and the battery receptacle 126 is accessible for placement or replacement of a battery (not shown).

In FIG. 1B, the door 114 is shown in a closed position. In implementations in which the door 114 is in the closed position the seal 120 engages a flange (not shown) to provide an environmental seal. In implementations in which the door 114 is in the closed position the battery interface 122 engages the battery to secure the battery in the battery receptacle 126.

As shown in FIG. 1A, the image capture apparatus 100 includes the battery receptacle 126 structured to form a portion of an interior surface of the body 102. The battery receptacle 126 includes operative connections (not shown) for power transfer between the battery and the image capture apparatus 100. In some implementations, the battery receptable 126 may be omitted. Although one battery receptacle 126 is shown in FIG. 1A, the image capture apparatus 100 may include multiple battery receptacles.

As shown in FIG. 1A, the image capture apparatus 100 includes the first microphone 128 structured on a front surface of the body 102. As shown in FIG. 1A, the image capture apparatus 100 includes a second microphone 130 structured on a top surface of the body 102. As shown in FIG. 1B, the image capture apparatus 100 includes the drain microphone 130 structured on a side surface of the body 102. The drain microphone 130 is a microphone located behind a drain cover, including a drainage channel 134 for draining liquid from audio components of the image capture apparatus 100, including the drain microphone 130. The image capture apparatus 100 may include other microphones (not shown) on other surfaces of the body 102. The microphones 128, 130 receive and record audio, such as in conjunction with capturing video or separate from capturing video. In some implementations, one or more of the microphones 128, 130 may be omitted or combined with other components of the image capture apparatus 100.

As shown in FIG. 1B, the image capture apparatus 100 includes the speaker 132 structured on a bottom surface of the body 102. The speaker 132 outputs or presents audio, such as by playing back recorded audio or emitting sounds associated with notifications. Although one speaker 132 is shown in FIG. 1B, the image capture apparatus 100 may include multiple speakers structured on respective surfaces of the body 102.

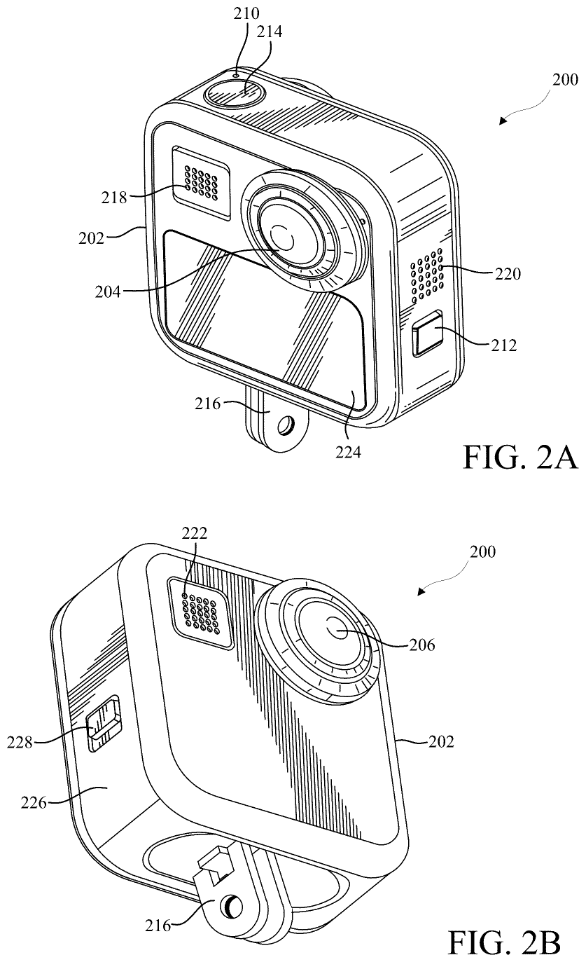

As shown in FIG. 1B, the image capture apparatus 100 includes the interconnect mechanism 136 structured on a bottom surface of the body 102. The interconnect mechanism 136 removably connects the image capture apparatus 100 to an external structure, such as a handle grip, another mount, or a securing device. As shown in FIG. 1B, the interconnect mechanism 136 includes folding protrusions configured to move between a nested or collapsed position as shown in FIG. 1B and an extended or open position (not shown in FIG. 1B). The folding protrusions of the interconnect mechanism 136 shown in the collapsed position in FIG. 1B may be similar to the folding protrusions of the interconnect mechanism 216 shown in the extended or open position in FIGS. 2A-2B, except as is described herein or as is otherwise clear from context. The folding protrusions of the interconnect mechanism 136 in the extended or open position may be coupled to reciprocal protrusions of other devices such as handle grips, mounts, clips, or like devices. Although one interconnect mechanism 136 is shown in FIG. 1B, the image capture apparatus 100 may include multiple interconnect mechanisms structured on, or forming a portion of, respective surfaces of the body 102. In some implementations, the interconnect mechanism 136 may be omitted.

As shown in FIG. 1B, the image capture apparatus 100 includes the display 138 structured on, and forming a portion of, a rear surface of the body 102. The display 138 outputs, such as presents or displays, such as by emitting visible light, data, such as to show image information such as image previews, live video capture, or status information such as battery life, camera mode, elapsed time, and the like. In some implementations, the display 138 may be an interactive display, which may receive, detect, or capture input, such as user input representing user interaction with the image capture apparatus 100. Although one display 138 is shown in FIG. 1B, the image capture apparatus 100 may include multiple displays structured on respective surfaces of the body 102. In some implementations, the display 138 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100.

Although not shown in FIGS. 1A-1B, the image capture apparatus 100 may communicate with an external device, such as an external user interface device (not shown), via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link. The external device may store, process, display, or combination thereof, the images. The external user interface device may be a computing device, such as a smartphone, a tablet computer, a phablet, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

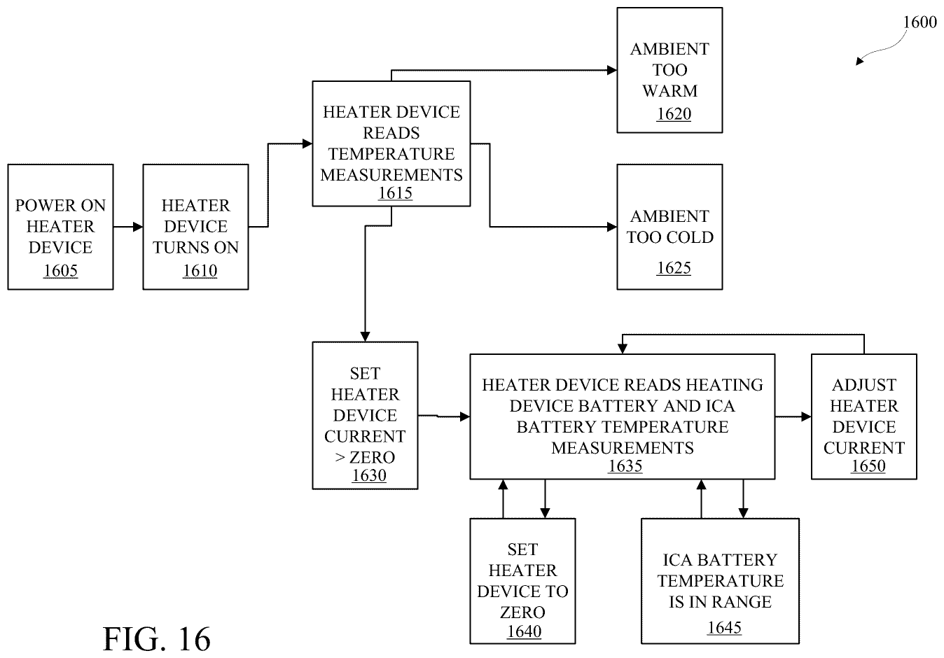

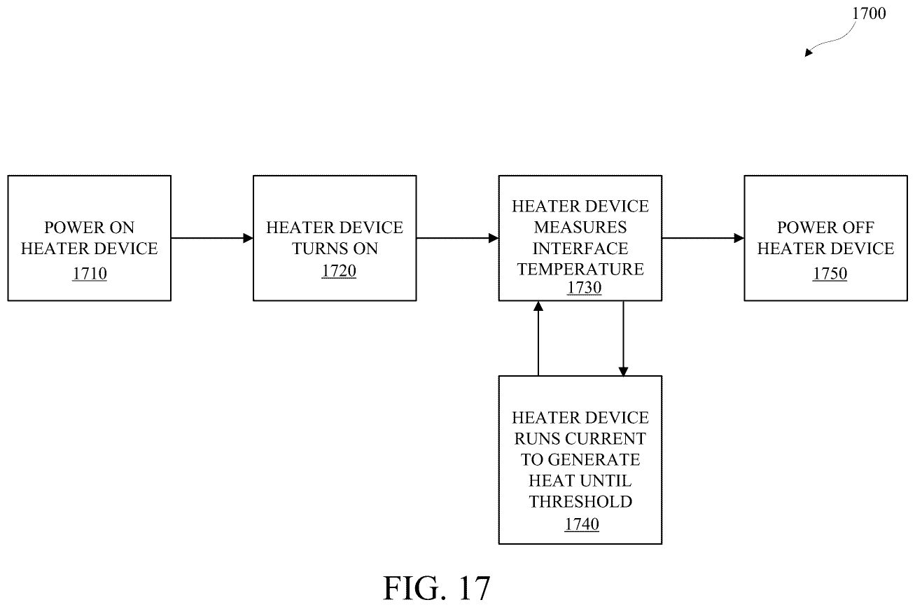

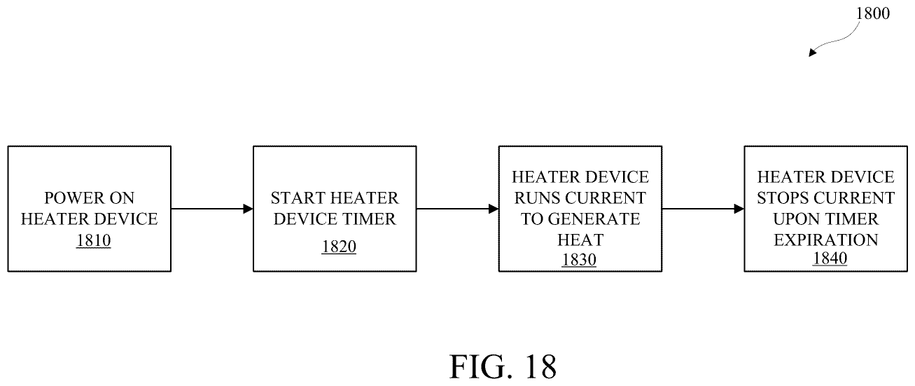

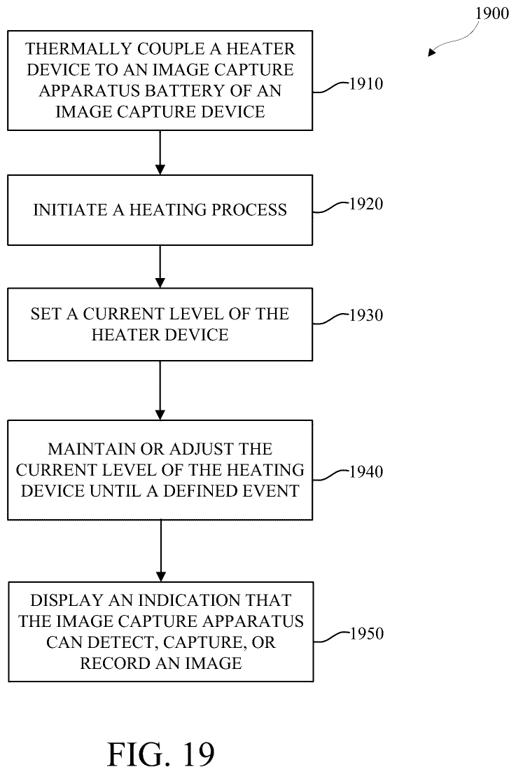

The image capture device 100 may be used to implement some or all of the techniques described in this disclosure, such as the technique 1600 described in FIG. 16, the technique 1700 described in FIG. 17, the technique 1800 described in FIG. 18, and the technique 1900 described in FIG. 19.

FIGS. 2A-2B illustrate another example of an image capture apparatus 200. The image capture apparatus 200 is similar to the image capture apparatus 100 shown in FIGS. 1A-B, except as is described herein or as is otherwise clear from context. The image capture apparatus 200 includes a body 202, a first image capture device 204, a second image capture device 206, indicators 210, a mode button 212, a shutter button 214, an interconnect mechanism 216, audio components 218, 220, 222, a display 224, and a door 226 including a release mechanism 228. The arrangement of the components of the image capture apparatus 200 shown in FIGS. 2A-2B is an example, other arrangements of elements may be used, except as is described herein or as is otherwise clear from context.

The body 202 of the image capture apparatus 200 may be similar to the body 102 shown in FIGS. 1A-1B, except as is described herein or as is otherwise clear from context.

As shown in FIG. 2A, the image capture apparatus 200 includes the first image capture device 204 structured on a front surface of the body 202. The first image capture device 204 includes a first lens. The first image capture device 204 may be similar to the image capture device 104 shown in FIG. 1A, except as is described herein or as is otherwise clear from context. As shown in FIG. 2B, the image capture apparatus 200 includes the second image capture device 206 structured on a rear surface of the body 202. The second image capture device 206 includes a second lens. The second image capture device 206 may be similar to the image capture device 104 shown in FIG. 1A, except as is described herein or as is otherwise clear from context. The image capture devices 204, 206 are disposed on opposing surfaces of the body 202, for example, in a back-to-back configuration, Janus configuration, or offset Janus configuration. Although two image capture devices 204, 206 are shown in FIGS. 2A-2B, the image capture apparatus 200 may include other image capture devices structured on respective surfaces of the body 202.

As shown in FIG. 2A, the image capture apparatus 200 includes the indicators 210 structured on a top surface of the body 202. The indicators 210 may be similar to the indicator 106 shown in FIG. 1A, except as is described herein or as is otherwise clear from context. For example, one of the indicators 210 may indicate a status of the first image capture device 204 and another one of the indicators 210 may indicate a status of the second image capture device 206. Although one indicator 210 is shown in FIGS. 2A-2B, the image capture apparatus 200 may include other indictors structured on respective surfaces of the body 202.

As shown in FIGS. 2A-B, the image capture apparatus 200 includes input mechanisms including a mode button 212, structured on a side surface of the body 202, and a shutter button 214, structured on a top surface of the body 202. The mode button 212 may be similar to the mode button 110 shown in FIG. 1B, except as is described herein or as is otherwise clear from context. The shutter button 214 may be similar to the shutter button 112 shown in FIG. 1A, except as is described herein or as is otherwise clear from context.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 3.

As shown in FIGS. 2A-2B, the image capture apparatus 200 includes the interconnect mechanism 216 structured on a bottom surface of the body 202. The interconnect mechanism 216 may be similar to the interconnect mechanism 136 shown in FIG. 1B, except as is described herein or as is otherwise clear from context. For example, the interconnect mechanism 136 shown in FIG. 1B is shown in the nested or collapsed position and the interconnect mechanism 216 shown in FIGS. 2A-2B are shown in an extended or open position.

As shown in FIGS. 2A-2B, the image capture apparatus 200 includes the audio components 218, 220, 222, respectively structured on respective surfaces of the body 202. The audio components 218, 220, 222 may be similar to the microphones 128, 130 and the speaker 128 shown in FIGS. 1A-1B, except as is described herein or as is otherwise clear from context. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts. As shown in FIG. 2A, a first audio component 218 is located on a front surface of the body 202. As shown in FIG. 2B, a second audio component 220 is located on a side surface of the body 202, and a third audio component 222 is located on a back surface of the body 202. Other numbers and configurations for the audio components may be used.

As shown in FIG. 2A, the image capture apparatus 200 includes the display 224 structured on a front surface of the body 202. The display 224 may be similar to the displays 108, 140 shown in FIGS. 1A-1B, except as is described herein or as is otherwise clear from context. The display 224 may include an I/O interface. The display 224 may receive touch inputs. The display 224 may display image information during video capture. The display 224 may provide status information to a user, such as status information indicating battery power level, memory card capacity, time elapsed for a recorded video, etc. Although one display 224 is shown in FIG. 2A, the image capture apparatus 200 may include multiple displays structured on respective surfaces of the body 202. In some implementations, the display 224 may be omitted or combined with another component of the image capture apparatus 200.

As shown in FIG. 2A, the image capture apparatus 200 includes the door 226 structured on, or forming a portion of, the side surface of the body 202. The door 226 may be similar to the door 114 shown in FIG. 1A, except as is described herein or as is otherwise clear from context. For example, the door 226 shown in FIG. 2A includes a release mechanism 228. The release mechanism 228 may include a latch, a button, or another mechanism configured to receive a user input that allows the door 226 to change position. The release mechanism 228 may be used to open the door 226 for a user to access a battery, a battery receptacle, an I/O interface, a memory card interface, etc. (not shown)

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

The image capture device 200 may be used to implement some or all of the techniques described in this disclosure, such as the technique 1600 described in FIG. 16, the technique 1700 described in FIG. 17, the technique 1800 described in FIG. 18, and the technique 1900 described in FIG. 19.

FIG. 3 is a block diagram of electronic components in an image capture apparatus 300. The image capture apparatus 300 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-B, or the image capture apparatus 200 shown in FIGS. 2A-B, may be implemented as shown in FIG. 3, except as is described herein or as is otherwise clear from context.

The image capture apparatus 300 includes a body 302. The body 302 may be similar to the body 102 shown in FIGS. 1A-1B, or the body 202 shown in FIGS. 2A-B, except as is described herein or as is otherwise clear from context. The body 302 includes electronic components such as capture components 310, processing components 320, data interface components 330, spatial sensors 340, power components 350, user interface components 360, and a bus 380.

The capture components 310 include an image sensor 312 for capturing images. Although one image sensor 312 is shown in FIG. 3, the capture components 310 may include multiple image sensors. The image sensor 312 may be similar to the image sensors 236, 240 shown in FIG. 2C, except as is described herein or as is otherwise clear from context. The image sensor 312 may be, for example, a charge-coupled device (CCD) sensor, an active pixel sensor (APS), a complementary metal-oxide-semiconductor (CMOS) sensor, or an N-type metal—oxide—semiconductor (NMOS) sensor. The image sensor 312 detects light, such as within a defined spectrum, such as the visible light spectrum or the infrared spectrum, incident through a corresponding lens such as the lens 230 with respect to the image sensor 236 as shown in FIG. 2C or the lens 232 with respect to the image sensor 240 as shown in FIG. 2C. The image sensor 312 captures detected light as image data and conveys the captured image data as electrical signals (image signals or image data) to the other components of the image capture apparatus 300, such as to the processing components 320, such as via the bus 380.

The capture components 310 include a microphone 314 for capturing audio. Although one microphone 314 is shown in FIG. 3, the capture components 310 may include multiple microphones. The microphone 314 detects and captures, or records, sound, such as sound waves incident upon the microphone 314. The microphone 314 may detect, capture, or record sound in conjunction with capturing images by the image sensor 312. The microphone 314 may detect sound to receive audible commands to control the image capture apparatus 300. The microphone 314 may be similar to the microphones 128, 130 shown in FIGS. 1A-1B or the audio components 218, 220, 222 shown in FIGS. 2A-2B, except as is described herein or as is otherwise clear from context.

The processing components 320 perform image signal processing, such as filtering, tone mapping, or stitching, to generate, or obtain, processed images, or processed image data, based on image data obtained from the image sensor 312. The processing components 320 may include one or more processors having single or multiple processing cores. In some implementations, the processing components 320 may include, or may be, an application specific integrated circuit (ASIC) or a digital signal processor (DSP). For example, the processing components 320 may include a custom image signal processor. The processing components 320 conveys data, such as processed image data, with other components of the image capture apparatus 300 via the bus 380. In some implementations, the processing components 320 may include an encoder, such as an image or video encoder that may encode, decode, or both, the image data, such as for compression coding, transcoding, or a combination thereof.

Although not shown expressly in FIG. 3, the processing components 320 may include memory, such as a random-access memory (RAM) device, which may be non-transitory computer-readable memory. The memory of the processing components 320 may include executable instructions and data that can be accessed by the processing components 320.

The data interface components 330 communicates with other, such as external, electronic devices, such as a remote control, a smartphone, a tablet computer, a laptop computer, a desktop computer, or an external computer storage device. For example, the data interface components 330 may receive commands to operate the image capture apparatus 300. In another example, the data interface components 330 may transmit image data to transfer the image data to other electronic devices. The data interface components 330 may be configured for wired communication, wireless communication, or both. As shown, the data interface components 330 include an I/O interface 332, a wireless data interface 334, and a storage interface 336. In some implementations, one or more of the I/O interface 332, the wireless data interface 334, or the storage interface 336 may be omitted or combined.

The I/O interface 332 may send, receive, or both, wired electronic communications signals. For example, the I/O interface 332 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 332 is shown in FIG. 3, the data interface components 330 include multiple I/O interfaces. The I/O interface 332 may be similar to the data interface 124 shown in FIG. 1A, except as is described herein or as is otherwise clear from context.

The wireless data interface 334 may send, receive, or both, wireless electronic communications signals. The wireless data interface 334 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 334 is shown in FIG. 3, the data interface components 330 include multiple wireless data interfaces. The wireless data interface 334 may be similar to the data interface 124 shown in FIG. 1A, except as is described herein or as is otherwise clear from context.

The storage interface 336 may include a memory card connector, such as a memory card receptacle, configured to receive and operatively couple to a removable storage device, such as a memory card, and to transfer, such as read, write, or both, data between the image capture apparatus 300 and the memory card, such as for storing images, recorded audio, or both captured by the image capture apparatus 300 on the memory card. Although one storage interface 336 is shown in FIG. 3, the data interface components 330 include multiple storage interfaces. The storage interface 336 may be similar to the data interface 124 shown in FIG. 1A, except as is described herein or as is otherwise clear from context.

The spatial, or spatiotemporal, sensors 340 detect the spatial position, movement, or both, of the image capture apparatus 300. As shown in FIG. 3, the spatial sensors 340 include a position sensor 342, an accelerometer 344, and a gyroscope 346. The position sensor 342, which may be a global positioning system (GPS) sensor, may determine a geospatial position of the image capture apparatus 300, which may include obtaining, such as by receiving, temporal data, such as via a GPS signal. The accelerometer 344, which may be a three-axis accelerometer, may measure linear motion, linear acceleration, or both of the image capture apparatus 300. The gyroscope 346, which may be a three-axis gyroscope, may measure rotational motion, such as a rate of rotation, of the image capture apparatus 300. In some implementations, the spatial sensors 340 may include other types of spatial sensors. In some implementations, one or more of the position sensor 342, the accelerometer 344, and the gyroscope 346 may be omitted or combined.

The power components 350 distribute electrical power to the components of the image capture apparatus 300 for operating the image capture apparatus 300. As shown in FIG. 3, the power components 350 include a battery interface 352, a battery 354, and an external power interface 356 (ext. interface). The battery interface 352 (bat. interface) operatively couples to the battery 354, such as via conductive contacts to transfer power from the battery 354 to the other electronic components of the image capture apparatus 300. The battery interface 352 may be similar to the battery receptacle 126 shown in FIG. 1A, except as is described herein or as is otherwise clear from context. The external power interface 356 obtains or receives power from an external source, such as a wall plug or external battery, and distributes the power to the components of the image capture apparatus 300, which may include distributing power to the battery 354 via battery interface 352 to charge the battery 354. Although one battery interface 352, one battery 354, and one external power interface 356 are shown in FIG. 3, any number of battery interfaces, batteries, and external power interfaces may be used. In some implementations, one or more of the battery interface 352, the battery 354, and the external power interface 356 may be omitted or combined. For example, in some implementations, the external interface 356 and the I/O interface 332 may be combined.

The user interface components 360 receive input, such as user input, from a user of the image capture apparatus 300, output, such as display or present, information to a user, or both receive input and output information, such as in accordance with user interaction with the image capture apparatus 300.

As shown in FIG. 3, the user interface components 360 include visual output components 362 to visually communicate information, such as to present captured images. As shown, the visual output components 362 include one or more indicator(s) or light(s) 364 and one or more displays 366. The indicator 364 may be similar to the indicator 106 shown in FIG. 1A or the indicators 210 shown in FIG. 2A, except as is described herein or as is otherwise clear from context. The display 366 may be similar to the display 108 shown in FIG. 1A, the display 138 shown in FIG. 1B, or the display 224 shown in FIG. 2A, except as is described herein or as is otherwise clear from context. Although the visual output components 362 are shown in FIG. 3 as including one indicator 364, the visual output components 362 may include multiple indicators. Although the visual output components 362 are shown in FIG. 3 as including one display 366, the visual output components 362 may include multiple displays. In some implementations, one or more of the indicator 364 or the display 366 may be omitted or combined.

As shown in FIG. 3, the user interface components 360 include a speaker 368. The speaker 368 may be similar to the speaker 132 shown in FIG. 1B or the audio components 218, 220, 222 shown in FIGS. 2A-B, except as is described herein or as is otherwise clear from context. Although one speaker 368 is shown in FIG. 3, the user interface components 360 may include multiple speakers. In some implementations, the speaker 368 may be omitted or combined with another component of the image capture apparatus 300, such as the microphone 314.

As shown in FIG. 3, the user interface components 360 include a physical input interface 370. The physical input interface 370 may be similar to the shutter button 112 shown in FIG. 1A, the mode button 110 shown in FIG. 1B, the shutter button 214 shown in FIG. 2A, or the mode button 212 shown in FIG. 2B, except as is described herein or as is otherwise clear from context. Although one physical input interface 370 is shown in FIG. 3, the user interface components 360 may include multiple physical input interfaces. In some implementations, the physical input interface 370 may be omitted or combined with another component of the image capture apparatus 300. The physical input interface 370 may be, for example, a button, a toggle, a switch, a dial, or a slider.

As shown in FIG. 3, the user interface components 360 include a broken line border box labeled “other” 372, to indicate that components of the image capture apparatus 300 other than the components expressly shown as included in the user interface components 360 may be user interface components. For example, the other 372 can be the microphone 314 to receive, or capture, and process audio signals to obtain input data, such as user input data corresponding to voice commands. In another example, the other 372 can be the image sensor 312 to receive, or capture, and process image data to obtain input data, such as user input data corresponding to visible gesture commands. In another example, the other 372 can be one or more of the spatial sensors 340, such as a combination of the accelerometer 344 and the gyroscope 346, to receive, or capture, and process motion data to obtain input data, such as user input data corresponding to motion gesture commands.

The image capture device 300 may be used to implement some or all of the techniques described in this disclosure, such as the technique 1600 described in FIG. 16, the technique 1700 described in FIG. 17, the technique 1800 described in FIG. 18, and the technique 1900 described in FIG. 19.

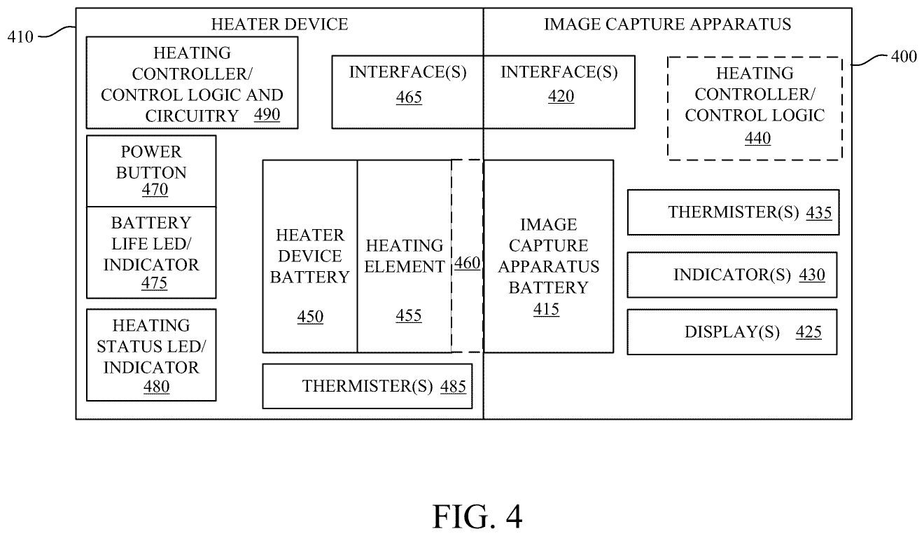

FIG. 4 is a block diagram of an example image capture apparatus 400 with an attached heater device 410. The image capture apparatus 400 is similar to the image capture apparatus 100 shown in FIGS. 1A-B, the image capture apparatus 200 shown in FIGS. 2A-C, and/or the image capture apparatus 300 shown in FIG. 3 except as is described herein or as is otherwise clear from context. The image capture apparatus 400 and the heater device 410 are illustrative and may include additional, fewer, or different devices, entities and the like which may be similarly or differently architected without departing from the scope of the specification and claims herein. The quantity of described devices or elements is illustrative. Moreover, the illustrated devices may perform other functions without departing from the scope of the specification and claims herein.

The image capture apparatus 400 includes an image capture apparatus battery 415, one or more interfaces 420, one or more displays 425, one or more indicators 430, one or more thermistors 435, and may include a heating controller or control logic 440.

The heater device 410 includes a heater device battery 450, a heating element 455, a heat spreader 460, one or more interfaces 465, a power button 470, a heater device battery life LED/indicator 475, a heating status LED/indicator 480, one or more thermistors 485, and a heating controller or control logic and circuitry 490. The heater device 410 can be turned on via a user selecting or pressing the power button 470. In implementations, the heater device 410 minimizes heat generation to a body of the image capture apparatus 400 and optimizes heat generation toward the image capture apparatus battery 415.

The image capture apparatus battery 415 can be the battery 354 as described herein. The image capture apparatus battery 415 can have an operating temperature at which the image capture apparatus 400 can provide an operational electrical power to functionally operate, e.g., capture and record images or video. For example, the operating temperature can be at or near 10° C. In some implementations, the image capture apparatus battery 415 can have a minimum operating temperature at which the image capture apparatus battery 415 can provide minimal electrical power to execute techniques or control logic for the heater device 410 via the heating controller or control logic 440 and provide a status indication using the one or more displays 425, the one or more indicators 430, and/or combinations thereof.

The one or more interfaces 420 and the one or more interfaces 465, as appropriate and applicable, can include thermal, electrical, and mechanical interfaces as described herein. The one or more interfaces 420 and the one or more interfaces 465 can enable thermal, electrical, and mechanical attachment of the heater device 410 to the image capture apparatus 400. The one or more interfaces 420 and the one or more interfaces 465 can enable communication of sensor data or temperature measurements, such as data from the one or more thermistors 435 and/or the one or more thermistors 485, and of control communications between the heater device 410 to the image capture apparatus 400, as appropriate and applicable. For example, this can be achieved using a USB type or cable connector or a prong type connector. In some implementations, the one or more interfaces 420 can include the data interface 124, the hinge mechanism 116, the latch mechanism 118, and the battery receptacle 126 of FIGS. 1A-B, as appropriate and applicable. In some implementations, the one or more interfaces 465 can include mating interfaces for the data interface 124, the hinge mechanism 116, the latch mechanism 118, and the battery receptacle 126 of FIGS. 1A-B, as appropriate and applicable.

The one or more displays 425 and the one or more indicators 430 can indicate the status of the image capture apparatus battery 415. In some implementations, the status can indicate an operational readiness, a temperature of the image capture apparatus battery 415, an ambient temperature, an error message, an overheating message, a status message, and/or combinations thereof. The one or more displays 425 and the one or more indicators 430 can be driven by the heating controller or control logic 440, the heating controller or control logic 490, and/or combinations thereof.

The heater device battery life LED/indicator 475 can indicate the status, power level, or capacity of the heater device battery 450. The heating status LED/indicator 480 can indicate the status of the image capture apparatus battery 415. In some implementations, the status can indicate operational readiness, overheating, an alert, and/or combinations thereof. The heater device battery life LED/indicator 475 and the heating status LED/indicator 480 can be driven by the heating controller or control logic 440, the heating controller or control logic and circuitry 490, and/or combinations thereof.

The one or more thermistors 435 can include thermistors for making or taking temperature measurements at or on an integrated sensor lens assembly board, image capture apparatus printed circuit board, the image capture apparatus battery 415, an ambient temperature, and other locations on the image capture apparatus 400. The temperature measurements can be read by the heating controller or control logic 440, the heating controller or control logic and circuitry and circuitry 490, and/or combinations thereof.

The one or more thermistors 485 can include thermistors for making or taking temperature measurements at or on the heater device battery 450, the heating element 455, the heat spreader 460, and other locations on the heater device 410. In some implementations, the thermistor at the heat spreader 460 can be referred to as an interface thermistor as the heat spreader 460, when attached to the image capture apparatus 400, is in contact with the image capture apparatus battery 415. The temperature measurements can be read by the heating controller or control logic 440, the heating controller or control logic and circuitry 490, and/or combinations thereof.

The heater device battery 450 can be a battery, battery pack, and/or power source which has an operational temperature less than that of the image capture apparatus battery 415. For example, the heater device battery 450 can be, but is not limited to, a Lithium polymer, battery, a Lithium ion battery, a Zinc-carbon battery, a Lithium Iron Disulfide battery, and/or a Lithium Iron Phosphate (LiFePO4) battery. The heater device battery 450 can provide, as controlled by the heating controller or control logic 440, the heating controller or control logic and circuitry 490, and/or combinations thereof, electrical power to drive the heating element 455.

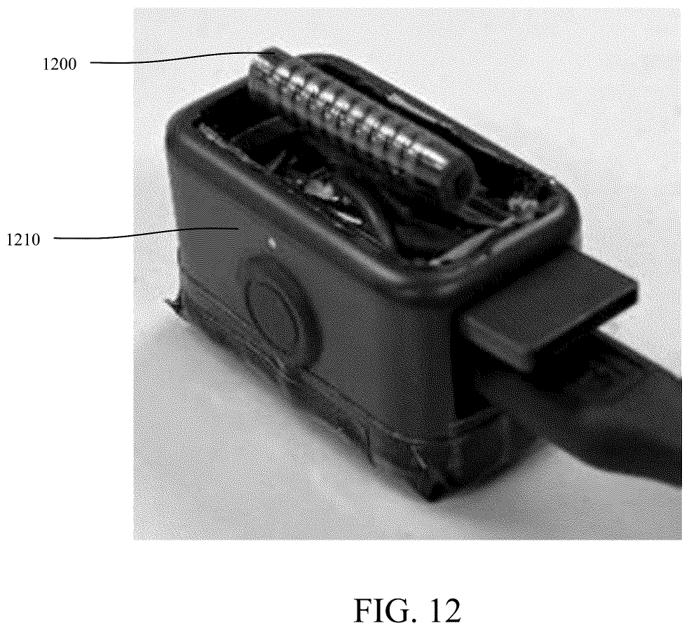

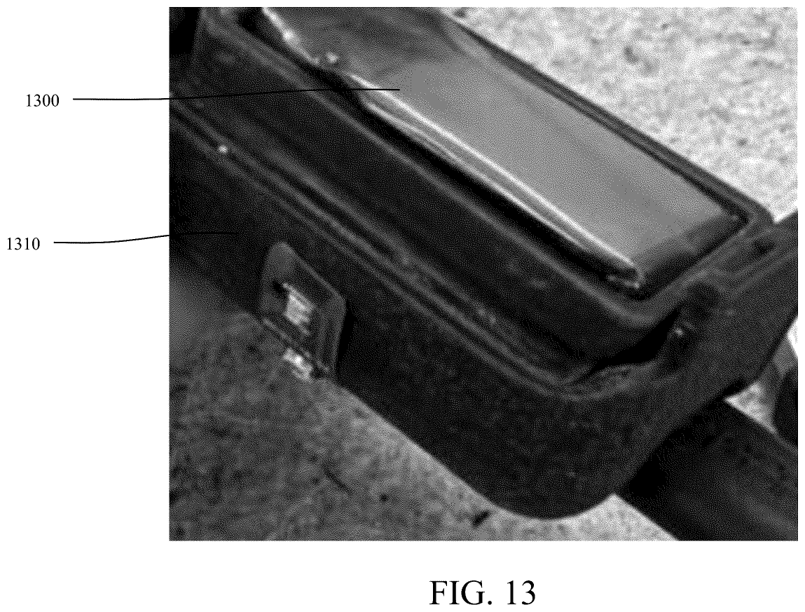

The heating element 455 can be a flexible polyimide heater plate, an electric heating pad, low power silicone rubber heater, polyimide film heater, a thermal sleeve, and other similar devices which generate heat when current is passed through associated resistive elements. The heating element 455 can be wrapped around the heater device battery 450, placed proximate to the heater device battery 450, and/or in other suitable configurations. FIG. 12 is a perspective view of an example heating element 1200 for a heater device 1210. In this example, the heating element 1200 is a flexible heater. FIG. 13 is a perspective view of another example heating element 1300 for a heater device 1310. In this example, the heating element 1300 is a positive temperature coefficient (PTC) heater, which consists of heating discs built from advanced ceramic materials.

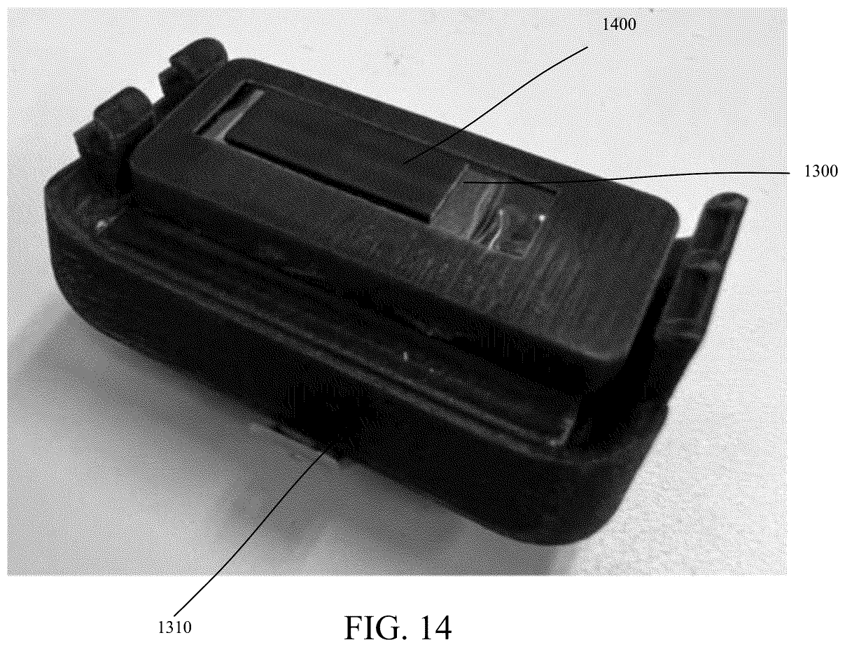

The heat spreader 460 can be device which is thermally conductive or made from a thermally conductive material and which can move heat from the heating element 455 to the image capture apparatus battery 415 as a result of cross sectional area, surface area, and/or volume. For example, the heat spreader 460 can be, but is not limited to, a graphite-mesh heat spreader. In some implementations, the heating element 455 and the heat spreader 460 can be an integrated device. FIG. 14 is a perspective view of a surface of a heat spreader 1400 for the heating element 1300 of the heater device 1310 of FIG. 13. For example, the heat spreader 1400 can be, but is not limited to, a graphite-mesh heat spreader.

The heating controller or control logic and circuitry 490 can control a current level of the heater device battery 450 by reading the one or more thermistors 435, the one or more thermistors 485, and/or combinations thereof and using the techniques described herein, such as for example, the technique 1600 described in FIG. 16, the technique 1700 described in FIG. 17, the technique 1800 described in FIG. 18, and the technique 1900 described in FIG. 19. Controlling the current level of the heater device battery 450 in turn controls the amount of heat generated by the heating element 455 and passed through by the heat spreader 460 to the image capture apparatus battery 415.

In instances where a temperature of the image capture apparatus battery 415 is at the minimum operating temperature or greater, the heating controller or control logic 440 can function as described for the heating controller or control logic and circuitry 490. In some implementations, the heating controller or control logic 440 can take over for the heating controller or control logic and circuitry 490. In some implementations, the heating controller or control logic and circuitry 490 and the heating controller or control logic 440 can work collectively or cooperatively to control the current level of the heater device battery 450 and consequently, the amount of heat generated.

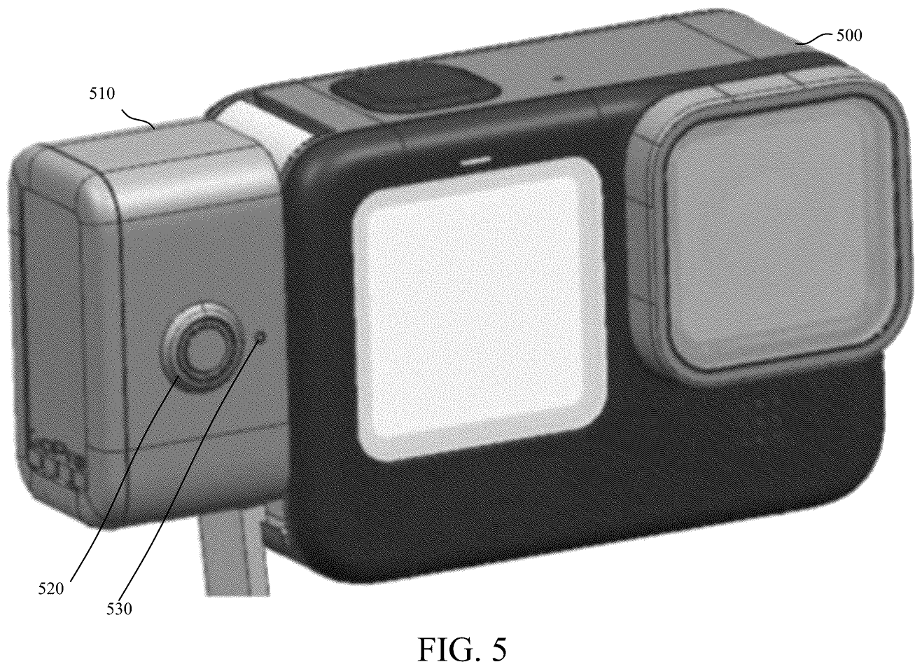

FIG. 5 is a perspective view of an example image capture apparatus 500 with an attached heater device 510. The image capture apparatus 500 can be, for example, the image capture apparatus 400 of FIG. 4. The heater device 510 can be, for example, the heater device 410 of FIG. 4. As shown, the heater device 510 can include a power button 520 and an indicator 530. The heater device 510 can be a cartridge which can snap fit, clip on, otherwise attach to the image capture apparatus 500. For example, the attachment can be accomplished using the one or more interfaces 420 and the one or more interfaces 465 as described in FIG. 4.

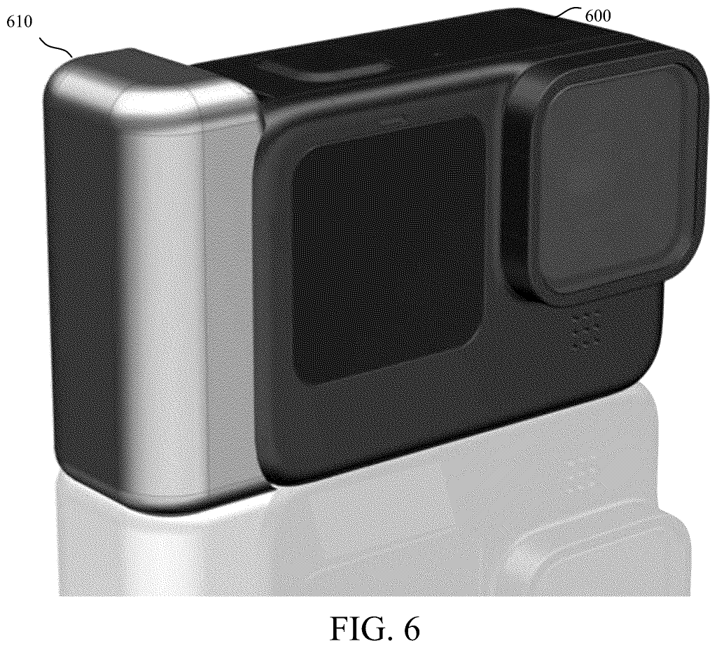

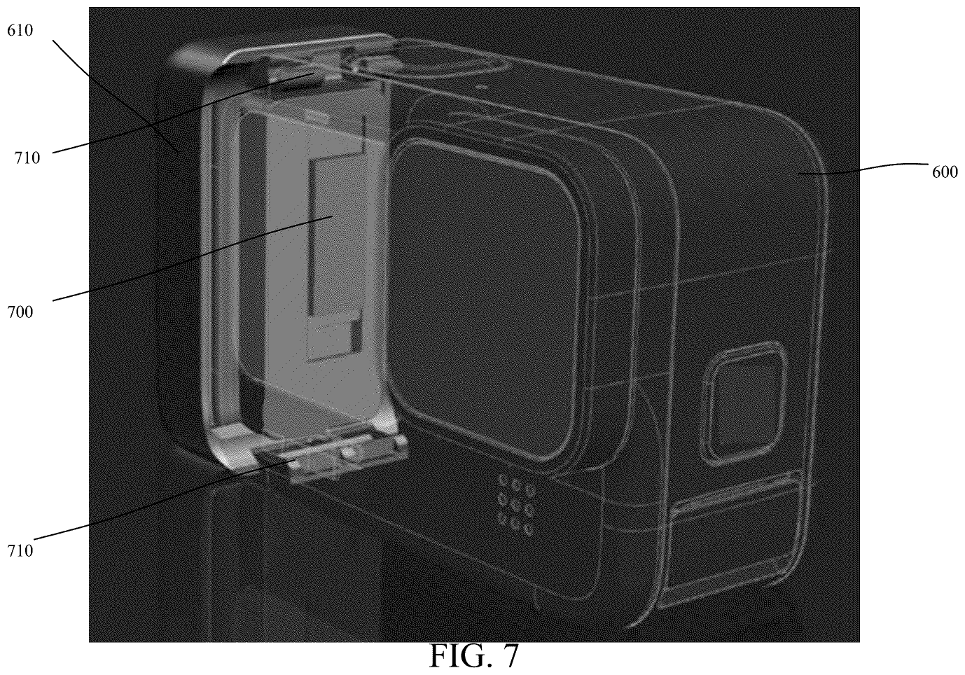

FIG. 6 is a perspective view of another example image capture apparatus 600 with an attached heater device 610. The image capture apparatus 600 can be, for example, the image capture apparatus 400 of FIG. 4. The heater device 610 can be, for example, the heater device 410 of FIG. 4. The heater device 610 can be a cartridge which can attach to the image capture apparatus 600 using a hinge type mechanism as shown in FIG. 7. In an example, the attachment can be accomplished using the one or more interfaces 420 and the one or more interfaces 465 as described in FIG. 4.

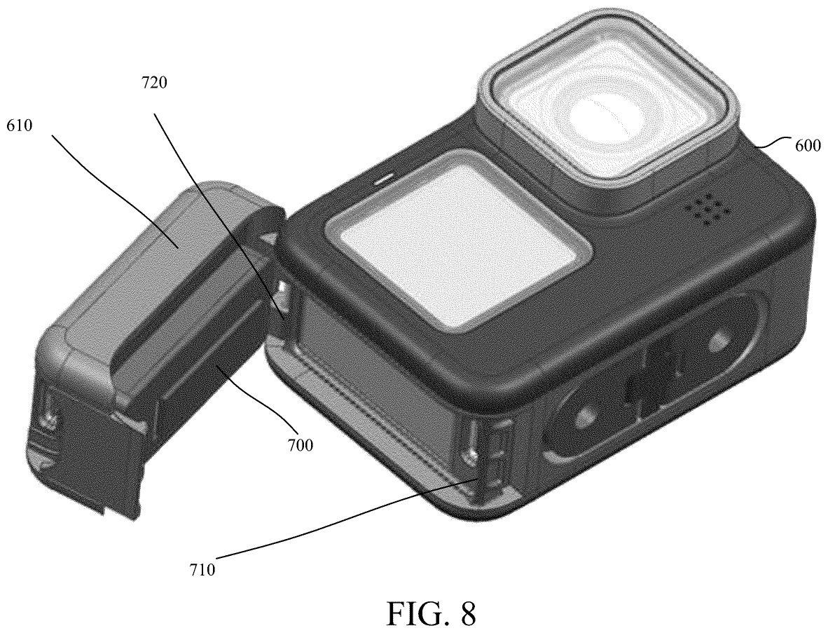

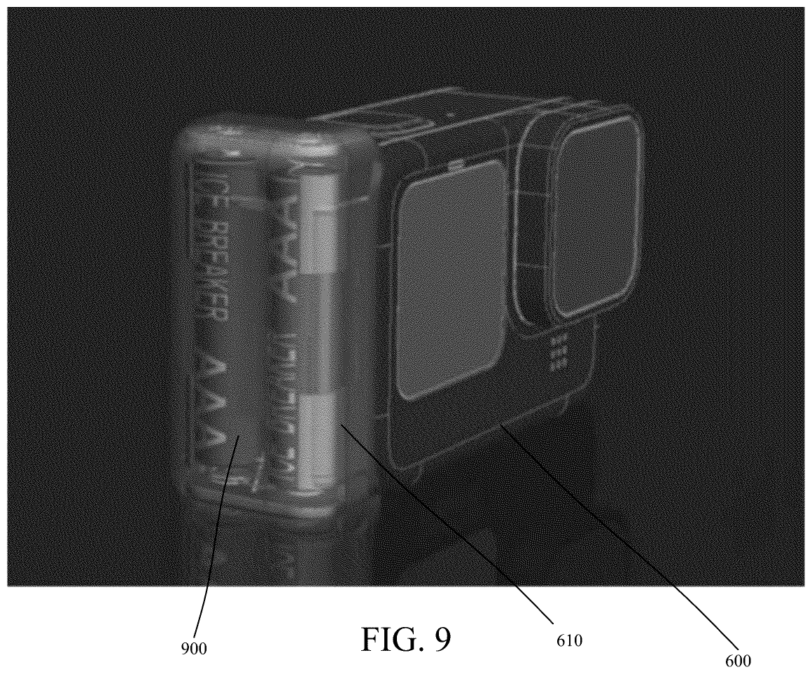

FIG. 7 is a partial non-occluded view of a surface of a heating element or heat spreader 700 of the example image capture apparatus 600 with the attached heater device 610 of FIG. 6. The heating element or heat spreader 700 can be the heating element 455, the heat spreader 460, and/or an integrated device thereof. As stated, the heater device 610 can be attached to the image capture apparatus 600 using a hinge type mechanism such as by using a hinge mechanism 710 and a latch mechanism 720. This is further illustrated in FIG. 8, which shows the heater device 610 in an open position. FIG. 9 is a partial non-occluded view of a heater device battery 900 of the example image capture apparatus 600 with the attached heater device 610 of FIG. 6.

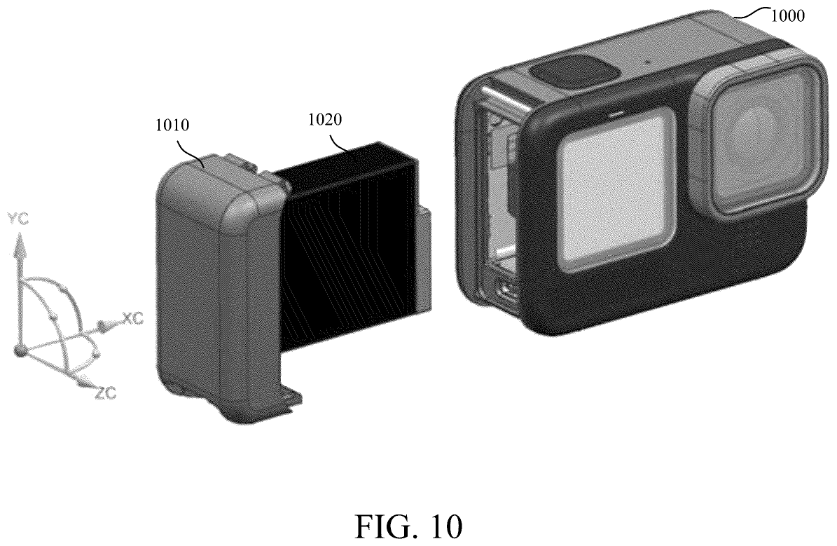

FIG. 10 is a perspective view of another example image capture apparatus 1000 with a heater device 1010. The image capture apparatus 1000 can be, for example, the image capture apparatus 400 of FIG. 4. The heater device 1010 can be, for example, the heater device 410 of FIG. 4. In some implementations, the heater device 1010 can include an image capture device battery 1020. The image capture device battery 1020 can be the image capture apparatus battery 415 of FIG. 4. The heater device 1010 can be a cartridge which can slide in and out of the image capture apparatus 1000 in a straight X insertion direction using a slider attachment mechanism, which also locks the heater device 1010 in place after insertion into the image capture apparatus 1000.

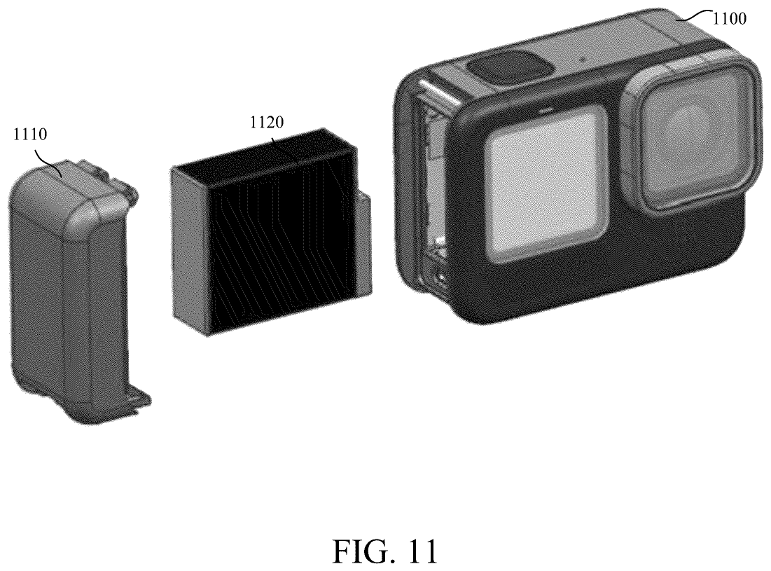

FIG. 11 is an exploded, perspective view of an example image capture apparatus 1100, a heater device 1110, and an image capture apparatus battery 1120. The image capture apparatus 1100 can be, for example, the image capture apparatus 400 of FIG. 4. The heater device 1110 can be, for example, the heater device 410 of FIG. 4. The image capture device battery 1120 can be the image capture apparatus battery 415 of FIG. 4. In some implementations, image capture apparatus battery 415 can be integrated with or be part of the heater device 1110. In this instance, the heater device 1110 can be a cartridge which can slide in and out of the image capture apparatus 1100 in a straight X insertion direction using a slider attachment mechanism, which also locks the heater device 1110 in place after insertion into the image capture apparatus 1100. In some implementations, image capture apparatus battery 415 can be slid into the image capture apparatus 1100 and then the heater device 1110 can be attached to the image capture apparatus 1100 as described herein.

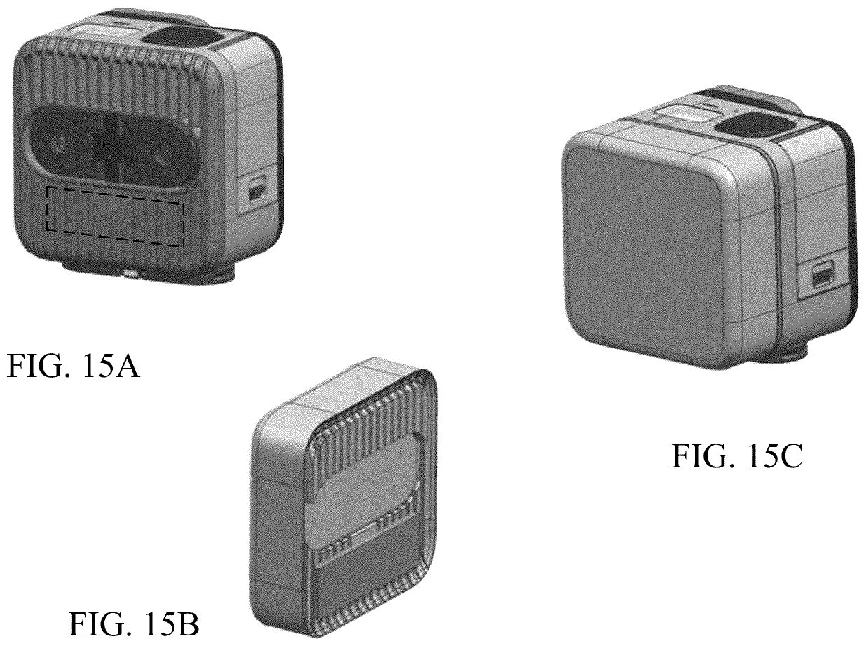

FIG. 15A is a perspective view of an example image capture apparatus 1500. The image capture apparatus 1500 can be, for example, the image capture apparatus 400 of FIG. 4. The image capture apparatus 1500 includes a battery (not shown) and a housing 1510. The battery is approximately or substantially positioned as indicated by a dashed box 1520 internally adjacent to a surface 1530 of the housing 1510. In some implementations, the housing 1510 includes one or more fins 1540 formed on the surface 1530.

FIG. 15B is a perspective view of an example heater device 1550. The heater device 1550 can be, for example, the heater device 410 of FIG. 4. In implementations, the heater device 1550 can include a thermal pad 1560 as described herein for heating the battery of the image capture apparatus 1500. In some implementations, heater device 1550 is coupled or thermally coupled to the surface 1530 of the housing 1510 of the image capture apparatus 1500 to heat the battery. In some implementations, the heater device 1550 is coupled or thermally coupled to the to the surface 1530 of the housing 1510 of the image capture apparatus 1500 such that the thermal pad 1560 is adjacent to the dashed box 1520, which represents placement of the battery inside the housing 1510 or the image capture apparatus 1500. FIG. 15C is a perspective view of the heater device 1550 coupled to the image capture apparatus 1500.

In some implementations, the heater device 1550 can heat other components in the image capture apparatus 1500 by placement of the thermal pad 1560 or other thermal pads in the appropriate place.

FIG. 16 is a flow diagram of an example technique 1600 for controlling heating of an image capture apparatus battery in an image capture apparatus using a heater device. The image capture apparatus can be, for example, the image capture apparatus 400 of FIG. 4, the image capture apparatus 500 of FIG. 5, the image capture apparatus 600 of FIG. 6, the image capture apparatus 1000 of FIG. 10, the image capture apparatus 1100 of FIG. 11, and/or the image capture apparatus 1500 of FIG. 15. The image capture apparatus battery can be, for example, the battery 354 of FIG. 3, the image capture apparatus battery 415 of FIG. 4, the image capture apparatus battery 1020 of FIG. 10, and/or the image capture apparatus battery 1120 of FIG. 11. The heater device can be, for example, the heater device 410 of FIG. 4, the heater device 510 of FIG. 5, the heater device 610 of FIG. 6, the heater device 1010 of FIG. 10, the heater device 1110 of FIG. 11, the heater device 1210 of FIG. 12, the heater device 1310 of FIG. 13, and/or the heater device 1550 of FIG. 15. The heater device can include a heater device battery, a heating element, and a heat spreader as described herein. The heater device battery has an operating temperature lower than that of the image capture apparatus battery.

In a scenario where the image capture apparatus is being used in an environment below an operating temperature of the image capture apparatus battery, the heater device is attached to image capture apparatus as described herein where the heating element and/or the heat spreader is in thermal contact with the image capture apparatus battery of the image capture apparatus. At 1605, a user turns on the heater device using, for example, a power button. The power button can be, for example, the power button 470 of FIG. 4 and/or the power button 520 of FIG. 5. At 1610, the heater device turns on and a heating controller can set the heater device current to zero (0). The heating controller can be, for example, the heating controller and control logic and circuitry 490, the heating controller and control logic 440, and/or combinations thereof as described herein. Indicators or messages can be displayed on the image capture apparatus, the heater device, and/or combinations thereof, as appropriate and applicable.

At 1615, the heating controller reads or obtains temperature measurements from one or more temperature sensors, thermistors, and the like. For example, the thermistors can be the one or more thermistors 435, the one or more thermistors 485, and/or combinations thereof. The heating controller can determine from the temperature measurements, an ambient temperature for the environment, an image capture apparatus battery temperature, and a heater device battery temperature.

At 1620, if the heating controller determines that the ambient temperature is above a first defined ambient threshold, then the image capture apparatus battery does not require heating. The first defined ambient threshold can be, for example, the operating temperature of the image capture apparatus battery. In this instance, the heater device is turned off and an indication or message is provided to the user that heating is not required. For example, a heating status LED or indicator can be set to red, a message or an error message can be displayed on the image capture apparatus, and/or other indicators can be used. At 1625, if the heating controller determines that the ambient temperature is below a second defined ambient threshold, then the ambient temperature is too cold and the operating temperature for the image capture apparatus battery is not attainable. The second defined ambient threshold can be, for example, a defined value below the operating temperature of the image capture apparatus battery. In this instance, the heater device is turned off and an indication or message is provided to the user that the operating temperature is not attainable. For example, a heating status LED or indicator can be set to red, a message or an error message can be displayed on the image capture apparatus, and/or other indicators can be used. Collectively, if the measured ambient temperature falls outside the first defined ambient threshold and the second defined ambient threshold (a heater device operational range), then the heater device is turned off and an error is indicated.

At 1630, if the measured ambient temperature is between the first defined ambient threshold and the second defined ambient threshold, and the image capture apparatus battery temperature is below the operating temperature of the image capture apparatus battery temperature, then the heating controller can set the heater device current to a defined initial or starting value. At 1635, the heating controller reads or obtains temperature measurements from one or more temperature sensors associated with the image capture apparatus battery (collectively “image capture apparatus battery thermistor(s)”) and one or more temperature sensors associated with the heater device battery (collectively “heater device battery thermistor(s)”).

At 1640, if the if the image capture apparatus battery temperature from the image capture apparatus battery thermistor(s) is equal to or greater than 0° C. (or a defined value above the operating temperature of the image capture apparatus battery) or the heater battery temperature from the heater device battery thermistor(s) is equal to or greater than 60° C. (or a defined value above the operating temperature of the heater device battery), then the heating controller sets the heater device current to zero (0) as either the image capture apparatus battery does not require further heating or the heater device is overheating, respectively. The heating controller displays an indication or message accordingly. For example, the heating controller can blink a color or use some other indication. At 1635, the heating controller again reads or obtains temperature measurements from the image capture apparatus battery thermistor(s) and the heater device battery thermistor(s). This can be repeated as needed to maintain the operating temperature. In some implementations, the heating device can be turned off.

At 1645, if the image capture apparatus battery temperature from the image capture apparatus battery thermistor(s) is greater than the operating temperature of the image capture apparatus battery, then the heating controller maintains the heater device current and an indicator or message is indicated of the current status. For example, the heating controller can display a green color, or use some other indication. In some implementations, the image capture apparatus can turn on automatically to start detecting, capturing, and/or recording images or video, as appropriate and applicable. At 1635, the heating controller again reads or obtains temperature measurements from the image capture apparatus battery thermistor(s) and the heater device battery thermistor(s). This can be repeated as needed to maintain the operating temperature.

At 1650, if the image capture apparatus battery temperature from the image capture apparatus battery thermistor(s) remains below the operating temperature of the image capture apparatus battery and the heater battery temperature from the heater device battery thermistor(s) remains below a third defined threshold, then the heating controller adjusts the heater device current. For example, the heating controller increases or decreases the heater device current based on current and previous temperature measurements. At 1635, the heating controller again reads or obtains temperature measurements from the image capture apparatus battery thermistor(s) and the heater device battery thermistor(s). This can be repeated as needed.

FIG. 17 is a flow diagram of another example technique 1700 for controlling heating of an image capture apparatus battery in an image capture apparatus using a heater device. The image capture apparatus can be, for example, the image capture apparatus 400 of FIG. 4, the image capture apparatus 500 of FIG. 5, the image capture apparatus 600 of FIG. 6, the image capture apparatus 1000 of FIG. 10, and/or the image capture apparatus 1100 of FIG. 11. The image capture apparatus battery can be, for example, the battery 354 of FIG. 3, the image capture apparatus battery 415 of FIG. 4, the image capture apparatus battery 1020 of FIG. 10, the image capture apparatus 1100 of FIG. 11, and/or the image capture apparatus 1500 of FIG. 15. The heater device can be, for example, the heater device 410 of FIG. 4, the heater device 510 of FIG. 5, the heater device 610 of FIG. 6, the heater device 1010 of FIG. 10, the heater device 1110 of FIG. 11, the heater device 1210 of FIG. 12, the heater device 1310 of FIG. 13, and/or the heater device 1550 of FIG. 15. The heater device can include a heater device battery, a heating element, and a heat spreader as described herein. The heater device battery has an operating temperature lower than that of the image capture apparatus battery. In some implementations, the heater device is a standalone device in that it has no electrical connections with the image capture device.

In a scenario where the image capture apparatus is being used in an environment below an operating temperature of the image capture apparatus battery, the heater device is attached to image capture apparatus as described herein where the heating element and/or the heat spreader is in thermal contact with the image capture apparatus battery of the image capture apparatus. At 1710, a user turns on the heater device using, for example, a power button. The power button can be, for example, the power button 470 of FIG. 4 and/or the power button 520 of FIG. 5. At 1720, the heater device turns on and a heating controller can set the heater device current to zero (0). The heating controller can be, for example, the heating controller and control logic and circuitry 490, the heating controller and control logic 440, and/or combinations thereof as described herein. Indicators or messages can be displayed on the image capture apparatus, the heater device, and/or combinations thereof, as appropriate and applicable.

At 1730, the heating controller reads or obtains temperature measurements from one or more temperature sensors, thermistors, and the like. For example, the thermistors can be the one or more thermistors 485 which can measure an interface temperature at or between the image capture apparatus battery and the heating element and/or the heat spreader, as appropriate and applicable. At 1740, the heating controller sets and/or adjusts the heater device current until the interface temperature attains the operating temperature of the image capture apparatus battery. At 1750, the heating controller sets the heater device current to zero (0) when the operating temperature of the image capture apparatus battery is attained. The heater device can remain on and heating controller can restart the heating process if the interface temperature falls below a defined threshold. Indicators or messages can be displayed indicating the progress or status of the heating operation. In some implementations, the user can turn off the heater device at any time.

FIG. 18 is a flow diagram of another example technique 1800 for controlling heating of an image capture apparatus battery in an image capture apparatus using a heater device. The image capture apparatus can be, for example, the image capture apparatus 400 of FIG. 4, the image capture apparatus 500 of FIG. 5, the image capture apparatus 600 of FIG. 6, the image capture apparatus 1000 of FIG. 10, the image capture apparatus 1100 of FIG. 11, and/or the image capture apparatus 1500 of FIG. 15. The image capture apparatus battery can be, for example, the battery 354 of FIG. 3, the image capture apparatus battery 415 of FIG. 4, the image capture apparatus battery 1020 of FIG. 10, and/or the image capture apparatus battery 1120 of FIG. 11. The heater device can be, for example, the heater device 410 of FIG. 4, the heater device 510 of FIG. 5, the heater device 610 of FIG. 6, the heater device 1010 of FIG. 10, the heater device 1110 of FIG. 11, the heater device 1210 of FIG. 12, the heater device 1310 of FIG. 13, and/or the heater device 1550 of FIG. 15. The heater device can include a heater device battery, a heating element, and a heat spreader as described herein. The heater device battery has an operating temperature lower than that of the image capture apparatus battery. In some implementations, the heater device is a standalone device in that it has no electrical connections with the image capture device.

In a scenario where the image capture apparatus is being used in an environment below an operating temperature of the image capture apparatus battery, the heater device is attached to image capture apparatus as described herein where the heating element and/or the heat spreader is in thermal contact with the image capture apparatus battery of the image capture apparatus. At 1810, a user turns on the heater device using, for example, a power button. The power button can be, for example, the power button 470 of FIG. 4 and/or the power button 520 of FIG. 5. At 1820, the heater device turns on and a heating controller turns on a timer in the heating controller. The timer has a defined run time. At 1830, a heating controller can adjust the heater device current to start the heating process. At 1840, the timer expires and the heating controller sets the heater device current to zero (0). The heating controller can be, for example, the heating controller and control logic and circuitry 490, the heating controller and control logic 440, and/or combinations thereof as described herein. Indicators or messages can be displayed on the image capture apparatus, the heater device, and/or combinations thereof, as appropriate and applicable.

FIG. 19 is a flowchart of an example technique 1900 for controlling heating of an image capture apparatus battery with an attached heater device. The technique 1900 includes: thermally attaching 1910 a heater device to an image capture apparatus battery of an image capture device; obtaining 1920 one or more temperature measurements indicative of a temperature of the image capture apparatus battery; setting 1930 a current level of the heater device; maintaining or adjusting 1940 the current level of the heater device until a defined event; and displaying 1950 an indication that the image capture apparatus can detect, capture, or record an image. For example, the technique 1700 may be implemented by the image capture apparatus 100 shown in FIGS. 1A-1B, the image capture apparatus 200 shown in FIGS. 2A-2C, the image capture apparatus 300 shown in FIG. 3, the image capture apparatus 400 of FIG. 4, the image capture apparatus 500 of FIG. 5, the image capture apparatus 600 of FIG. 6, the image capture apparatus 1000 of FIG. 10, the image capture apparatus 1100 of FIG. 11, the image capture apparatus 1500 of FIG. 15, the heater device 410 of FIG. 4, the heater device 510 of FIG. 5, the heater device 610 of FIG. 6, the heater device 1010 of FIG. 10, the heater device 1110 of FIG. 11, the heater device 1210 of FIG. 12, the heater device 1310 of FIG. 13, and/or the heater device 1550 of FIG. 15, as appropriate and applicable, and using the techniques described herein such as the technique 1600 of FIG. 16, the technique 1700 of FIG. 17, and/or the technique 1800 of FIG. 18, as appropriate and applicable.

The technique 1900 includes thermally attaching 1910 a heater device to an image capture apparatus battery of an image capture device. In a scenario where the image capture apparatus is being used in an environment below an operating temperature of the image capture apparatus battery, the heater device is attached to image capture apparatus as described herein. A heater device battery has an operational temperature lower than that of the image capture apparatus battery. A heating element and/or heat spreader is in thermal contact with the image capture apparatus battery of the image capture apparatus. In some implementations, attachment of the heater device to the image capture apparatus battery can include thermal, mechanical, electrical, and signal or communication attachments. In some implementations, attachment of the heater device to the image capture apparatus battery can include thermal and mechanical attachments and no electrical, signal, or communication attachments.

The technique 1900 includes initiating 1920 a heating process. In some implementations, initiating the heating process can include obtaining one or more temperature measurements indicative of a temperature of the image capture apparatus battery. In some implementations, a heating controller can read temperature measurements from one or more thermistors. In some implementations, the thermistors are located in the heater device, in the image capture device, and/or combinations thereof. In some implementations, the one or more temperature measurements indicative of the temperature of the image capture apparatus battery is taken at an interface between the image capture apparatus battery and the heating element and/or heat spreader. In some implementations, the one or more temperature measurements indicative of the temperature of the image capture apparatus battery include an ambient temperature, an image capture device apparatus battery temperature, and a heater device battery. In some implementations, initiating the heating process can include setting a heating timer.

The technique 1900 includes setting 1930 a current level of the heater device. In some implementations, the current level is set to a defined level. In some implementations, the current level is set based on temperature measurements. If the temperature measurements indicate that an ambient or environmental temperature is above a defined threshold where the image capture apparatus battery can already operate functionally, i.e., detect, capture, or record an image, then the current level of the heater device is set to zero, a status is indicated, and the heater device can be turned off. If the temperature measurements indicate that an ambient or environmental temperature is below a defined threshold where the image capture apparatus battery cannot be warmed up to operate functionally, i.e., detect, capture, or record an image, then the current level of the heater device is set to zero, a status is indicated, and the heater device can be turned off. If the temperature measurements indicate that a temperature is within a defined range, the current level of the heater device is set to the defined level.

The technique 1900 includes maintaining or adjusting 1940 the current level of the heater device until a defined event. In some implementations, the current level of the heater device is maintained until expiration of the timer. In some implementations, the current level of the heater device is adjusted until the temperature measurements indicate that the temperature of the image capture apparatus battery has reached the operational temperature of the image capture apparatus battery. In some implementations, the current level of the heater device is set to zero when the temperature measurements indicate that the heater device battery is overheating. In some implementations, the current level of the heater device is set to zero when the temperature measurements indicate that the image capture apparatus battery is a defined value above the operational temperature of the image capture apparatus battery. In some implementations, the current level of the heater device is maintained when the temperature measurements indicate that the image capture apparatus battery is at operational temperature of the image capture apparatus battery. This is done to maintain the operational temperature of the image capture apparatus battery.

The technique 1900 includes displaying 1950 an indication that the image capture apparatus can detect, capture, or record an image. In accordance with different statuses of the heater device, the image capture apparatus device, and/or combinations thereof, light based indicators, status messages, messages, and/or combinations thereof can be used to alert the user.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture system, comprising:
an image capture apparatus including an image capture apparatus battery configured to functionally operate at a first operational temperature;
a heater device including a heater device battery configured to operate at a second operational temperature lower than the first operational temperature, the heater device configured to thermally couple to the image capture apparatus battery; and
at least one of the image capture apparatus or the heater device including a heater controller configured to:
initiate a heating process based on a first defined event;
set a current level of the heater device;
maintain or adjust the current level of the heater device until a second defined event; and
display an indication that the image capture apparatus can detect, capture, or record an image based on the image capture apparatus battery attaining the first operational temperature.

2. The image capture system of claim 1, wherein the heater device includes a heating element and a heat spreader.

3. The image capture system of claim 1, wherein the heater controller is further configured to:
set the current level of the heater device to zero upon initiation of the heating process;
read one or more temperature measurements indicative of a temperature of the image capture apparatus battery, wherein the first defined event indicates that the one or more temperature measurements fall within a heater device operational range and the second defined event is attained when an image capture apparatus battery temperature attains the first operational temperature; and
adjust the current level of the heater device, wherein the read and adjust are repeated until the second defined event.

4. The image capture system of claim 3, wherein the heater controller is further configured to:
turn off the heater device when the one or more temperature measurements include an ambient temperature indicating that heating of the image capture apparatus battery is unnecessary.

5. The image capture system of claim 3, wherein the heater controller is further configured to:
turn off the heater device when the one or more temperature measurements include an ambient temperature indicating that heating of the image capture apparatus battery to the first operational temperature is unattainable.

6. The image capture system of claim 3, wherein the heater controller is further configured to:
set the current level of the heater device to zero when the one or more temperature measurements include a heater device battery temperature indicating that the heater device battery is overheating.

7. The image capture system of claim 3, wherein the heater controller is further configured to:
set the current level of the heater device to zero when the one or more temperature measurements include the image capture apparatus battery temperature indicating that the image capture apparatus battery temperature is at a defined value above the first operational temperature.

8. The image capture system of claim 3, wherein the heater controller is further configured to:
maintain the current level of the heater device when the one or more temperature measurements include the image capture apparatus battery temperature indicating that the image capture apparatus battery temperature is at the first operational temperature.

9. The image capture system of claim 1, wherein the first defined event occurs when a timer is set by the heater controller and the second defined event occurs when the timer expires, the heater controller is further configured to:
set the current level of the heater device to zero upon initiation of the heating process; and
set the current level of the heater device to zero when the second defined event occurs.

10. The image capture system of claim 1, wherein the heater controller is further configured to:
set the current level of the heater device to zero upon initiation of the heating process;
read one or more temperature measurements indicative of a temperature of the image capture apparatus battery, wherein the one or more temperature measurements is an interface temperature measurement and the first defined event indicates that an interface temperature measurement is below the first operational temperature and second defined event is attained when the interface temperature measurement attains the first operational temperature; and
adjust the current level of the heater device, wherein the read and adjust are repeated until the second defined event.

11. A method for heating an image capture apparatus battery using a heater device, the method comprising:
thermally coupling a heater device to an image capture apparatus battery of an image capture device, wherein a heater device battery operational temperature is lower than an image capture apparatus battery operational temperature;
obtaining one or more temperature measurements indicative of a temperature of the image capture apparatus battery;
setting a current level of the heater device;
maintaining or adjusting the current level of the heater device until a defined event; and
displaying an indication that the image capture apparatus can detect, capture, or record an image.

12. The method of claim 11, wherein the setting further comprises:
determining that the one or more temperature measurements fall within a heater device operational range.

13. The method of claim 11, the method further comprises:
foregoing the setting when the one or more temperature measurements indicate that heating of the image capture apparatus battery is unnecessary.

14. The method of claim 11, the method further comprises:
foregoing the setting when the one or more temperature measurements indicate that heating of the image capture apparatus battery to an operational temperature of the image capture apparatus battery is unattainable.

15. The method of claim 11, the method further comprises:
setting the current level of the heater device to zero when the one or more temperature measurements include a heater device battery temperature indicating that the heater device battery is overheating.

16. The method of claim 11, the method further comprises:
setting the current level of the heater device to zero when the one or more temperature measurements include an image capture apparatus battery temperature indicating that the image capture apparatus battery temperature is at a defined value above the image capture apparatus battery operational temperature.

17. The method of claim 11, the method further comprises:
maintaining the current level of the heater device when the one or more temperature measurements include an image capture apparatus battery temperature indicating that the image capture apparatus battery temperature is at the image capture apparatus battery operational temperature.

18. The method of claim 11, wherein the one or more temperature measurements are taken from the heater device.

19. A method for heating an image capture apparatus battery using a heater device, the method comprising:
thermally attaching a heater device to an image capture apparatus battery of an image capture device, wherein a heater device battery operational temperature is lower than an image capture apparatus battery operational temperature;
setting a timer;
setting a current level of the heater device;
maintaining the current level of the heater device until expiration of the timer; and
displaying an indication that the image capture apparatus can detect, capture, or record an image.

20. The method of claim 19, the method further comprises:
turning off the heater device by a user irrespective of the timer.
